(19) United States
(12) Patent Application Publication
(10) Pub. No.: US 2015/0370857 A1
(43) Pub. Date: Dec. 24, 2015

(54) MULTI-DIMENSIONAL DATA STATISTICS

(71) Applicants: Anisoara Nica, Waterloo (CA); Curtis Kroetsch, Waterloo (CA)

(72) Inventors: Anisoara Nica, Waterloo (CA); Curtis Kroetsch, Waterloo (CA)

(21) Appl. No.: 14/466,512

(22) Filed: Aug. 22, 2014

Related U.S. Application Data
(60) Provisional application No. 62/013,807, filed on Jun. 18, 2014.

(51) Int. Cl. G06F 17/30

(52) U.S. Cl. CPC G06F 17/30477; G06F 17/30589

(57) ABSTRACT

A system, computer-implemented method, and computer-program product embodiments for generating a multi-dimensional histogram. A data statistic object generator creates an initial histogram, determines a cost associated with each bucket of the histogram, sorts the buckets into a queue based on the determined cost and selects one of the buckets to be decomposed based on the determined cost. The cost of the decomposed buckets are then calculated, and the decomposed are buckets are then put back into the queue of histogram buckets for possible further decomposition.

This application claims priority to U.S. Provisional Appl. No. 62/013,807, filed Jun. 18, 2014, which is incorporated by reference herein in its entirety.

### BACKGROUND

Computer databases have become a prevalent means for data storage and retrieval. Due to the lowering cost of memory as well as increasing computing speeds, databases today can be large. Users of a database who wish to ascertain trends and statistics concerning data in the database may find that performing such calculations can be cumbersome given the large amounts of data in the database

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the relevant art to make and use the embodiments.

FIG. 1 is an example database computing environment in which embodiments can be implemented.

FIG. 2 is an example data plot of information in a database according to an embodiment.

FIG. 3 is an example histogram of a database according to an embodiment.

FIG. 4 illustrates example bucket distributions according to an embodiment.

FIG. 5 is a flow chart for bucket decomposition in an n-dimensional histogram according to an embodiment.

FIG. 6 is a block diagram of an example computer system in which embodiments may be implemented.

### DETAILED DESCRIPTION

Provided herein are system, method and/or computer program product embodiments, and/or combinations and sub-combinations thereof, for generating cardinality estimates, where cardinality estimates are used for generating an improved or optimal query plan for a query.

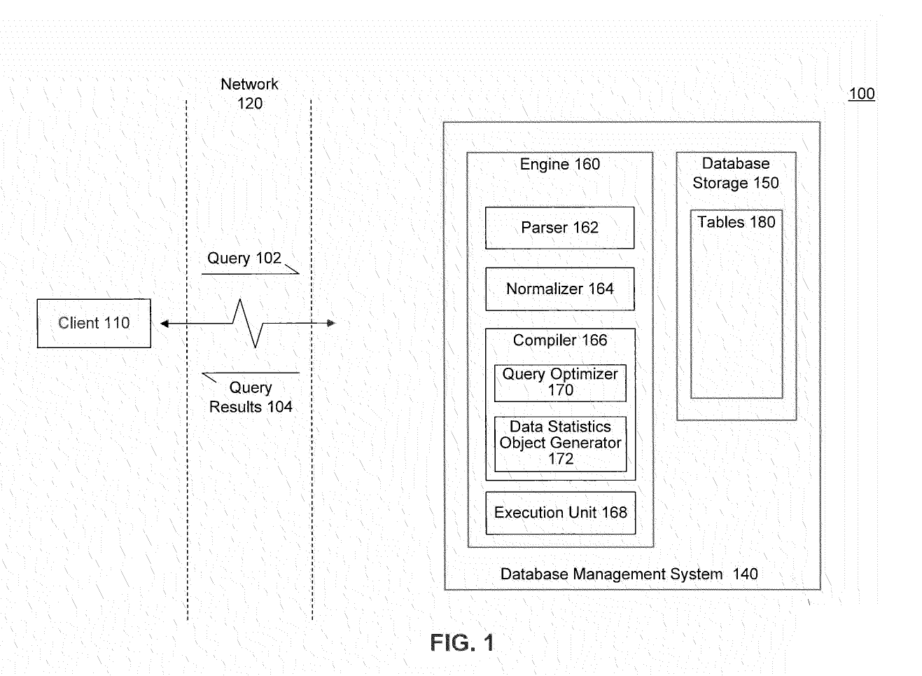

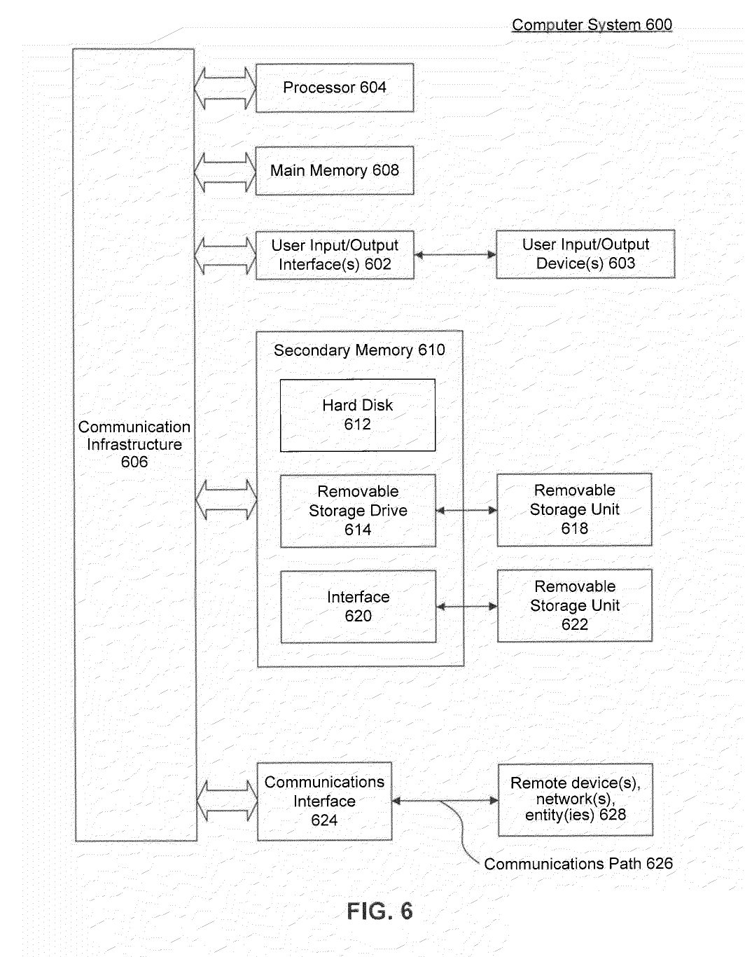

FIG. 1 is an example database computing environment 100 in which embodiments can be implemented. Computing environment 100 includes a database management system (DBMS) 140 and client 110 that communicates DBMS 140. DBMS 140 may be a system executing on a server and accessible to client 110 over a network, such as network 120, described below. Although client 110 is represented in FIG. 1 as a separate physical machine from DBMS 140, this is presented by way of example, and not limitation. In an additional embodiment, client 110 occupies the same physical system as DBMS 140. In a further embodiment, client 110 is a software application which requires access to DBMS 140. In another embodiment, a user may operate client 110 to request access to DBMS 140. Throughout this specification, the terms client and user will be used interchangeably to refer to any hardware, software, or human requestor, such as client 110, accessing DBMS 140 either manually or automatically. Additionally, both client 110 and DBMS 140 may execute within a computer system, such as an example computer system discussed in FIG. 6.

Client 110 and DBMS 140 may communicate over network 120. Network 120 may be any network or combination of networks that can carry data communications. Such a network 120 may include, but is not limited to, a local area network, metropolitan area network, and/or wide area network that include the Internet.

DBMS 140 receives a query, such as query 102, from client 110. Query 102 is used to request, modify, append, or otherwise manipulate or access data in database storage 150. Query 102 is transmitted to DBMS 140 by client 110 using syntax which conforms to a query language. In a non-limiting embodiment, the query language is a Structured Query Language (“SQL”), but may be another query language. DBMS 140 is able to interpret query 102 in accordance with the query language and, based on the interpretation, generate requests to database storage 150.

Query 102 may be generated by a user using client 110 or by an application executing on client 110. Upon receipt, DBMS 140 begins to process query 102. Once processed, the result of the processed query is transmitted to client 110 as query result 104.

To process query 102, DBMS 140 includes a parser 162, a normalizer 164, a compiler 166, and an execution unit 168.

Parser 162 parses the received queries 102. In an embodiment, parser 162 may convert query 102 into a binary tree data structure which represents the format of query 102. In other embodiments, other types of data structures may be used.

When parsing is complete, parser 162 passes the parsed query to a normalizer 164. Normalizer 164 normalizes the parsed query. For example, normalizer 164 eliminates redundant SQL constructs from the parsed query. Normalizer 164 also performs error checking on the parsed query that confirms that the names of the tables in the parsed query conform to the names of tables 180. Normalizer 164 also confirms that relationships among tables 180, as described by the parsed query, are valid.

Once normalization is complete, normalizer 164 passes the normalized query to compiler 166. Compiler 166 compiles the normalized query into machine-readable format. The compilation process determines how query 102 is executed by DBMS 140. To ensure that query 102 is executed efficiently, compiler 166 uses a query optimizer 170 to generate an access plan for executing the query.

Query optimizer 170 analyzes the query and determines a query plan for executing the query. The query plan retrieves and manipulates information in the database storage 150 in accordance with the query semantics. This may include choosing the access method for each table accessed, choosing the order in which to perform a join operation on the tables, and choosing the join method to be used in each join operation. As there may be multiple strategies for executing a given query using combinations of these operations, query optimizer 170 generates and evaluates a number of strategies from which to select the best strategy to execute the query.

In an embodiment, query optimizer 170 generates multiple query plans. Once generated, query optimizer 170 selects a query plan from the multiple query plans to execute the query. The selected query plan may be a cost efficient plan, a query plan that uses the least amount of memory in DBMS 140, a query plan that executes the quickest, or any combination of the above, to give a few examples.

In an embodiment, in order for query optimizer 170 to generate and select a query plan, DBMS 140 uses a data statistic object generator 172 to estimate the computational cost of a particular query plan. Data statistic object generator 172 can provide an estimate of the size (i.e., number of rows) of a query plan before the query plan is executed. Based on the estimate, query optimizer 170 selects an efficient query plan that executes query 102 from multiple query plans.

Providing accurate data statistics is important, since the query optimizer 170 relies on them to generate query plans. Inaccurate statistics can cause the DBMS to inefficiently execute queries. Generating query plans by analyzing the database elements can be computationally cumbersome if the database is large. Data statistic objects can work to estimate properties of the database, thus obviating the need to analyze database elements each time a query plan is being created.

Table 1 (below) illustrates an example set of data according to an embodiment. The data set illustrated by Table 1 can be organized into a columnar database.

TABLE 1

| X | Y |
|---|---|
| 18 | 580 |
| 15 | 1258 |
| 83 | 1872 |
| 71 | 663 |
| 53 | 320 |
| 20 | 827 |
| 69 | 1367 |

Both the X column and Y column can represent particular attributes of a tuple in a database. As an example, X can represent a person's age while Y can represent their height in centimeters. If a query optimizer 170 wanted to calculate the computational cost of ascertaining how many people in the database were between the ages of 10-30 and had a height between 200-1000 cm the calculation would be straightforward since the dataset is small and thus the calculation could be performed by scanning the entire database. While the data set represented by Table 1 is relatively small, in general, databases can store large amounts of data. In databases that store large amounts of information, it can be computationally expensive and time consuming to perform the scan described above. Thus, data statistic objects can be employed to provide the query optimizer 170 with estimates rather than requiring a full scan of the database. However, in order to be useful to the query optimizer, the data statistics generated should be accurate while at the same time computationally efficient.

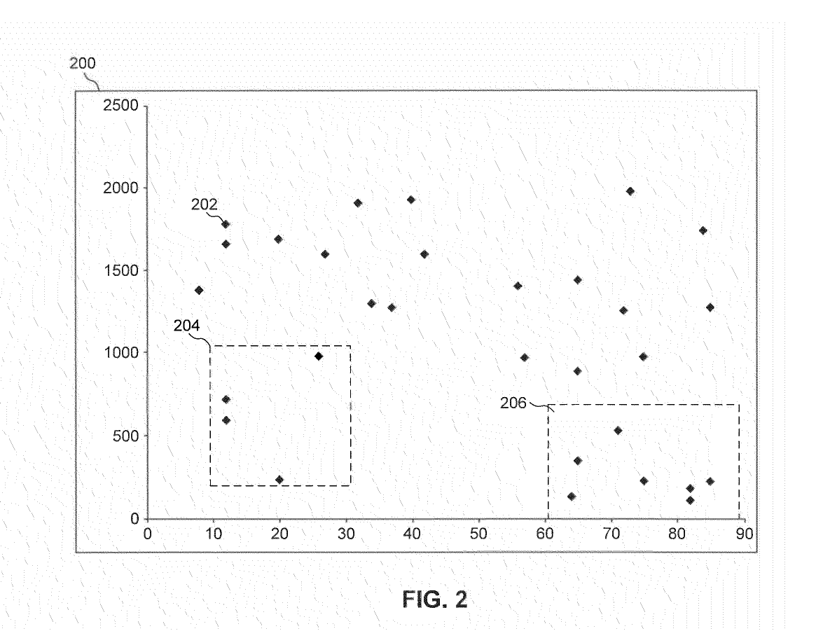

Histograms are an example of a type of data object. A histogram is a summary of a dataset over multiple dimensions. Histrograms are used to answer statistical questions about the data they approximate. One example of a statistical question is the cardinality of queries. The cardinality of a query is the number of data elements returned by the query. These cardinalities can be used by query optimizers to cost and compare query plans. A dataset can be defined by a collection of distinct points, wherein each point is uniquely identified by its location in multi-dimensional space. As an example, FIG. 2 is an example data plot of information in a database according to an embodiment. Each data point 202 in plot 200 can represent the age (x-axis) and height (y-axis) in multi-dimensional space of a given person in a database, for example.

Histograms can provide summaries of the data in a given space of the plot. Histograms are generally represented as a collection of buckets, wherein each bucket stores some information about a hyper-space from the dataset. As an example, a bucket 204 can be created to summarize the data within the bucket. Bucket 204 can provide a summary of the space bounded by age 10-30 on the x-axis and height 200-1000 cm on the y-axis. As illustrated, there are 4 data points that are within the bucket 204. The histogram can thus record that 4 points exist within the hyper-space bounded by bucket 204. Once this information is recorded, the data can be stored and provided to a query optimizer in order to generate optimal query plans. There is no longer a need to scan the database for the purpose of preparing query plans. As another example, bucket 206 can contain points bounded by ages 60-90 and heights 0-750 cm. As illustrated, bucket 206 contains 7 points. This information can also be used by the query optimizer 170 to generate optimal query plans.

Histograms as data objects can be constrained by the amount of space required to store them. In an embodiment, the size of a particular histogram is proportional to the number of buckets contained within the histogram. Therefore the number of buckets contained by a histogram can be constrained by the memory space available to store the histogram. The accuracy of a histogram to estimate the data space is proportional to the number of buckets contained within the histograms. The more buckets contained within a particular histogram can lead to a higher degree of accuracy. This is because more buckets means that each individual bucket has a smaller hyperspace.

The queries of interest (i.e., the queries being analyzed to create query plan) for the histogram being analyzed are range queries. A range query is a conjunction of restraints on each dimension of the dataset. A range query can be represented by a hyper-rectangle. The estimation of statistical questions for a range query using a histogram can be made by aggregating the information contained within buckets of the histogram that intersect the hyper-rectangle of the range query.

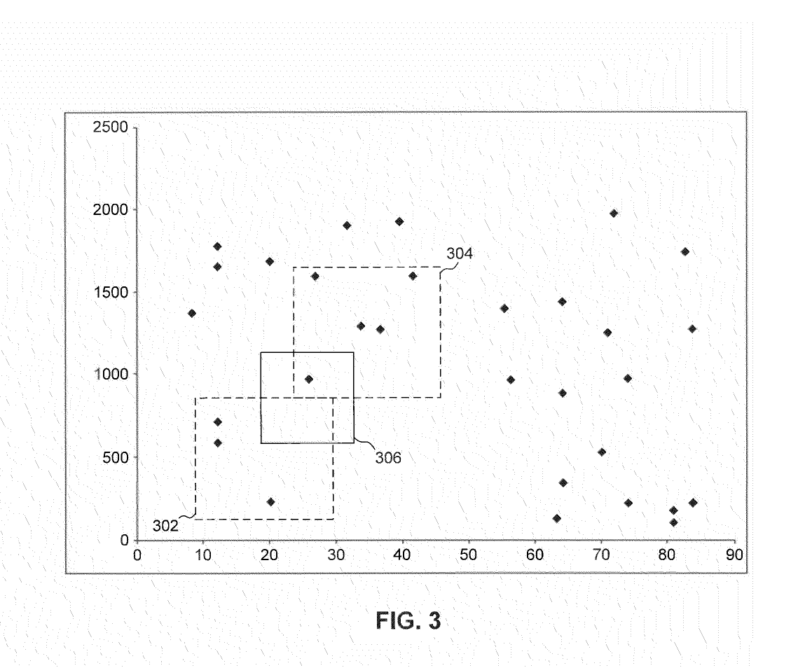

FIG. 3 illustrates an example intersection between a range query and buckets of a histogram. A range query 306, for purposes of illustration, can be mapped onto the data plot as discussed above with reference to FIG. 2. Range query 306, as illustrated in the example of FIG. 3, can represent a range query to find the cardinality for data between 20-35 years of age and for 500-1200 cm in height. A data statistic object generator 172 can have a histogram stored within it. The histogram can also be mapped to the data plot for purposes of illustration. As illustrated, buckets 302 and 304 can provide summaries of the cardinality estimate in the hyper-space bounded by the bucket. In order to estimate the cardinality of the range query 306, the information stored in intersecting hyper-spaces of the histogram can be aggregated at buckets that intersect the range query. Thus the cardinality estimates provided by buckets 304 and 306 can be aggregated to generate a cardinality estimate of range query 306.

A histogram can be generated from a given database using rK-Hist, introduced by Eavis and Lopez in “rK-Hist: An R-tree Based Histogram for Multi-dimensional Selectivity Estimation” (CIKM, pages 475-484, 2007). The rK-Hist is built on top of an r-tree which uses rectangles as the leaves of the tree, but can be generalized to an n-dimensional rectangle.

An r-tree is a hierarchical tree, much like a b-tree, but extended to multiple dimensions. Each leaf node of the r-tree is a point from the dataset, while each internal node is the Minimum Bounding Box (MBB) for its children. The MBB for a set of points is the box that encapsulates each point, with minimal volume. Hence the root of the r-tree contains a single box that represents the MBB over the entire dataset. On each level of the r-tree, nodes are permitted to overlap with one another, yet the boxes do not share children. An r-tree has a specified branching factor, chosen to optimize search-time in the tree. A typical search for a point would check if the root node intersects with the point, and if so it would recursively search its children. If a leaf-node could not be reached, the point is not in the dataset.

The quality of an r-tree depends on the algorithm that groups together points and boxes to eliminate dead space. An internal node whose MBB is large makes it difficult to search efficiently. An effective clustering algorithm groups together objects that are close to one another. A Hilbert Space-Filling Curve (SFC) is used to sort the points such that adjacent points in the ordering are close to one another in the hyper-space. A space-filling curve is a continuous curve which fills an entire n-dimensional space and has some defined origin. The distance between any point on the curve and the origin is unique. Using these distances, any multi-dimensional point can be mapped to a single-dimensional point (the distance) along the curve. Other SFCs can be used, such as the Morton SFC which may be easier to compute, but the Hilbert SFC is useful for most if not all well-known SFCs. An r-tree can be created using the Hilbert SFC by first sorting all points according to their distance along the Hilbert SFC, then evenly distributing adjacent points to leaf-boxes. These leaf-boxes are the histogram's buckets.

The construction of the rK-Hist follows from the Hilbert-packed r-tree described above. Since the histogram is meant to fit entirely in memory, creating the entire R-Tree is impractical for many datasets. Instead, a coarser r-tree from the bottom-up that can fit in memory is created. First, the number of buckets the histogram will have is determined based on the amount of memory available to store the histogram. In an embodiment, each bucket holds only one piece of information, the density. The density of a bucket is the ratio of the number of points in the bucket to the volume of the buckets' MBB. The tree is recursively packed until only the root node remains.

In an embodiment, the estimated cardinality of a range query is equal to the sum of the estimated cardinalities of each intersecting bucket as described above. Each of these buckets can be found by searching for the query box in the r-tree index. For each bucket the estimation is equal to the product of the volume of the intersection and the density of the bucket.

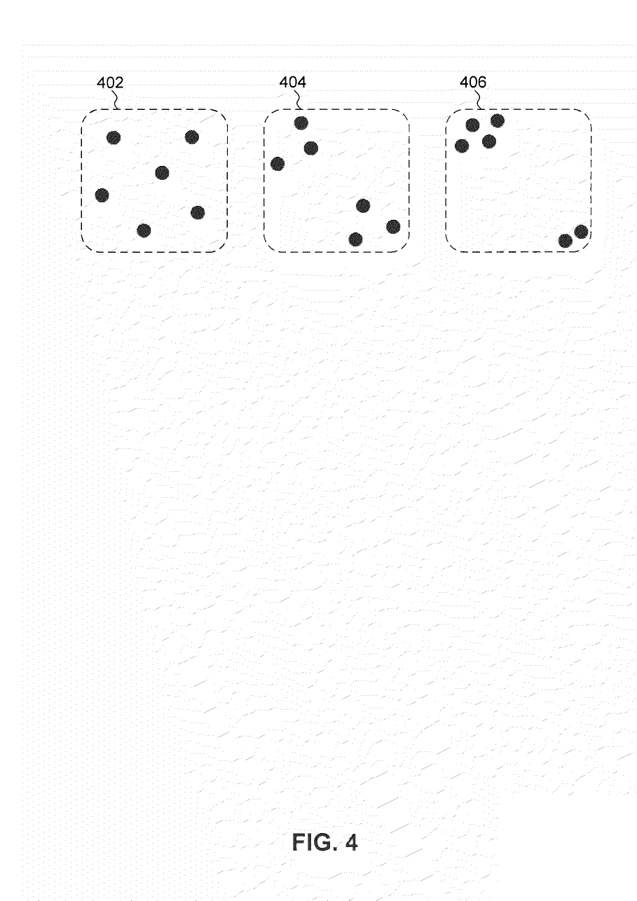

The Hilbert SFC may not produce optimal bucketing. The accuracy of aggregating intersecting histogram hyper-spaces with range query hyper-spaces to produce estimates of cardinality is dependent on how uniform the bucket is. A non-uniform bucket means that the data points contained within a bucket are very far apart. FIG. 4 illustrates example buckets distributions according to an embodiment. The buckets in the example of FIG. 4, bucket 402, 404 and 406 each have six points within them. The buckets have increasingly worse distributions from left to right (i.e., bucket 404 is worse than 402, and bucket 406 is worse than both 402 and 404). Since the size of the buckets and the amount of points in each bucket are the same for buckets 402, 404 and 406, they all have the same density.

Non-uniform buckets can have a detrimental effect on cardinality estimation for a particular range query. As an example, referring back to FIG. 3, range query 306 intersects both buckets 304 and 302. However, as illustrated, despite intersecting with bucket 302, range query 306 does not contain any points that are present in bucket 302. Therefore, using an aggregation of bucket 302 based on its density will yield inaccurate results since the true overlap is zero while the estimated aggregation based on density is non-zero.

To improve cardinality estimates using histograms, a cost function can be used to evaluate the uniformity of a bucket to determine if the points should be re-bucketed during the histogram building process. The cost function can assess whether points within a given bucket are uniformly spread throughout the bucket or whether the bucket contains large amounts of empty space which could lead to inaccurate estimates for range queries.

A K-Uniformity metric is an example of a cost function and can be employed to assess the “cost” (i.e., the uniformity) of a given bucket. The K-Uniformity metric can be calculated by recursively partitioning the points in a bucket into their own box, via a k-d tree. The K-Uniformity is the standard deviation of the volume in each box. The higher this metric, the worse the distribution is inside the bucket. The K-Uniformity metric can be complex since the algorithm still requires that original data points from the database be available (they may need to be read into again in main memory). Another cost function that can be applied to assess bucket non-uniformity is one that is based on the volume of the minimum bounding box. In an embodiment, this cost function can be represented by the following formula:

C(ω)=Volume(minimum bounding box(ω))

Wherein ω represents a bucket of the histogram.

If the cost function yields a poor result, the building algorithm can be employed to decompose the bucket. In other words, the poorly distributed bucket can be broken down into two or more smaller buckets. As an example, a sliding window approach proposed by Eavis and Lopez (CIKM pages 475-484) can be used to create smaller buckets. Employing smaller buckets can ensure better uniformity for each bucket, however the more buckets contained in the histogram, the more expensive it is from a memory standpoint.

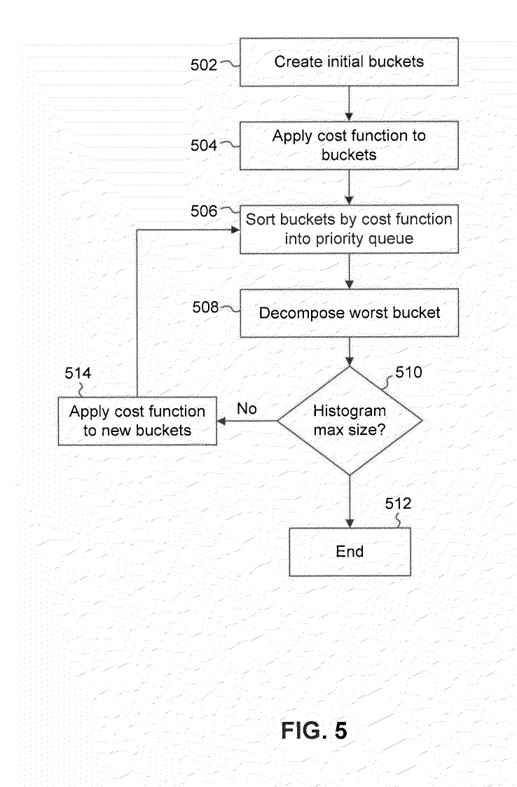

FIG. 5 is a flowchart of an exemplary method for bucket decomposition in an n-dimensional histogram. At 502 a histogram can be initially created using the methods and processes described above. The histogram can be created with a number of initial buckets that is less than the maximum capacity of the memory allocated for the histogram. By starting with a number of initial buckets that is less than the maximum capacity, there will be leftover capacity to store new buckets that are created as a result of the bucket decomposition process.

At 504, a cost function can be applied to the buckets to assess the non-uniformity of each bucket as described above. Once the each bucket has a cost function associated with it, the process can move to 506 wherein the buckets are sorted in a priority queue.

The priority queue can represent a ranking of the buckets, wherein the top of the queue lists the bucket with the highest cost function (i.e., the worst bucket with the highest degree of non-uniformity) and wherein the bottom of the priority queue can represent the bucket with the lowest cost function. At 508, the algorithm can decompose the bucket that is highest on the queue thereby creating new buckets out of the bucket that is highest on the queue.

At 510, the size of the histogram with the newly created buckets can be compared to the maximum allowed size of the histogram. If the maximum size is reached with the newly created buckets the bucket decomposition process can be terminated at 512. If however, more space exists for further bucket decomposition, the newly created buckets can have the cost function applied to them at 514 to assess their degree of non-uniformity. The newly created buckets can then be sorted back into the priority queue at 506 based on the cost function analysis and their cost relative to the remaining buckets in the queue in an order as described above. The process can then repeat until the maximum histogram size is reached.

FIG. 6 is a block diagram of an example computer system in which embodiments may be implemented. Various embodiments can be implemented, for example, using one or more well-known computer systems, such as computer system 600 shown in FIG. 6.

Computer system 600 can be any well-known computer capable of performing the functions described herein, such as computers available from International Business Machines, Apple, Sun, HP, Dell, Sony, Toshiba, etc.

Computer system 600 includes one or more processors (also called central processing units, or CPUs), such as a processor 604. Processor 604 is connected to a communication infrastructure or bus 606.

One or more processors 604 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 600 also includes user input/output device(s) 603, such as monitors, keyboards, pointing devices, etc., which communicate with communication infrastructure 606 through user input/output interface(s) 602.

Computer system 600 also includes a main or primary memory 608, such as random access memory (RAM). Main memory 1308 may include one or more levels of cache. Main memory 608 has stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618: Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to an exemplary embodiment, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

In an embodiment, a tangible apparatus or article of manufacture comprising a tangible computer useable or readable medium having control logic (software) stored thereon is also referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use the embodiments using data processing devices, computer systems and/or computer architectures other than that shown in FIG. 6. In particular, embodiments may operate with software, hardware, and/or operating system implementations other than those described herein.

It is to be appreciated that the Detailed Description section, and not the Summary and Abstract sections (if any), is intended to be used to interpret the claims. The Summary and Abstract sections (if any) may set forth one or more but not all exemplary embodiments as contemplated by the inventor(s), and thus, are not intended to limit the embodiments or the appended claims in any way.

While the embodiments have been described herein with reference to exemplary embodiments for exemplary fields and applications, it should be understood that the embodiments are not limited thereto. Other embodiments and modifications thereto are possible, and are within the scope and spirit of the embodiments. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the embodiments should not be limited by any of the above-described exemplary embodiments, but should be defined only in accordance with the following claims and their equivalents.

What is claimed is:

1. A computer-implemented method for generating a multi-dimensional histogram, comprising:
generating a plurality of histogram buckets, wherein each bucket is based on a plurality of data points;
determining a cost associated with each bucket of the plurality of buckets;
sorting the buckets in a queue based on the determined cost of each bucket;
selecting one bucket of the plurality of buckets, wherein the selection is based on a position of each bucket in the queue; and
decomposing the selected bucket into a plurality of decomposed buckets;
wherein at least one of the generating, determining, sorting, selecting, and decomposing are performed by one or more computers.

2. The computer-implemented method of claim 1, further comprising:
determining a cost associated with each of the plurality of decomposed buckets; and
placing the plurality of decomposed buckets into the queue, wherein the placement of the decomposed buckets into the queue is based on the determined cost of each decomposed bucket;

3. The computer-implemented method of claim 2, wherein determining a cost associated with each bucket of the plurality of buckets and each decomposed bucket of the plurality of decomposed buckets further includes determining a uniformity of data points within each bucket.

4. The computer implemented method of claim 3, wherein placing the plurality of decomposed buckets into the queue includes determining a uniformity of each decomposed bucket and placing the decomposed buckets into the queue based on the determined uniformity.

5. The computer-implemented method of claim 3, wherein determining a uniformity of the data points within each bucket and decomposed bucket includes calculating a K-Uniformity metric of each bucket of the plurality of buckets.

6. The computer implemented method of claim 3, wherein sorting the buckets in a queue further includes placing a bucket with a least amount of uniformity at a beginning of the queue and a bucket with a most amount of uniformity at an end of the queue, and wherein the queue is processed from the beginning of the queue to the end of the queue.

7. The computer implemented method of claim 1, wherein decomposing the selected bucket into a plurality of decomposed buckets includes dividing the selected bucket into a plurality of smaller buckets.

8. A system for generating a multi-dimensional histogram, comprising:
a memory; and
a processor coupled to the memory and configured to:
generate a plurality of histogram buckets, wherein each bucket is based on a plurality of data points;
determine a cost associated with each bucket of the plurality of buckets;
sort the buckets in a queue based on the determined cost of each bucket;
select one bucket of the plurality of buckets, wherein the selection is based on a position of each bucket in the queue; and
decompose the selected bucket into a plurality of decomposed buckets;

9. The system of claim 8, wherein the processor is further configured to:
determine a cost associated with each of the plurality of decomposed buckets; and
place the plurality of decomposed buckets into the queue, wherein the placement of the decomposed buckets into the queue is based on the determined cost of each decomposed bucket.

10. The system of claim 9, wherein the processor when determining a cost associated with each bucket of the plurality of buckets and each decomposed bucket of the plurality of decomposed buckets is further configured to determine the uniformity of the data points within each bucket.

11. The system of claim 10, wherein the processor when placing the plurality of decomposed buckets into the queue is further configured to determine a uniformity of each decomposed bucket and place the decomposed buckets into the queue based on the determined uniformity.

12. The system of claim 10, wherein the processor when determining a uniformity of the data points within each bucket and decomposed bucket is further configured to calculate a K-Uniformity metric of each bucket of the plurality of buckets.

13. The system of claim 10, wherein the processor when sorting the buckets in a queue is further configured to place a bucket with a least amount of uniformity at a beginning of the queue and a bucket with a most amount of uniformity at an end of the queue, and wherein the queue is processed from the beginning of the queue to the end of the queue.

14. The system of claim 8, wherein the processor when decomposing the selected bucket into a plurality of decomposed buckets is further configured to divide the selected bucket into a plurality of smaller buckets.

15. A tangible computer-readable device having instructions stored thereon that, when executed by at least one computing device, causes the at least one computing device to perform operations that generate a multi-dimensional histogram, the operations comprising:
generating a plurality of histogram buckets, wherein each bucket is based on a plurality of data points;
determining a cost associated with each bucket of the plurality of buckets;
sorting the buckets in a queue based on the determined cost of each bucket;
selecting one bucket of the plurality of buckets, wherein the selection is based on a position of each bucket in the queue; and
decomposing the selected bucket into a plurality of decomposed buckets;

16. The device of claim 15, wherein the operations further comprise:
determining a cost associated with each of the plurality of decomposed buckets; and
placing the plurality of decomposed buckets into the queue, wherein the placement of the decomposed buckets into the queue is based on the determined cost of each decomposed bucket.

17. The device of claim 16, wherein determining a cost associated with each bucket of the plurality of buckets and each decomposed bucket of the plurality of decomposed buckets further includes determining a uniformity of data points within each bucket.

18. The device of claim 17, wherein placing the plurality of decomposed buckets into the queue includes determining a uniformity of each decomposed bucket and placing the decomposed buckets into the queue based on the determined uniformity.

19. The device of claim 17, wherein determining a uniformity of the data points within each bucket and decomposed bucket includes calculating a K-Uniformity metric of each bucket of the plurality of buckets.

20. The device of claim 17, wherein sorting the buckets in a queue further includes placing a bucket with a least amount of uniformity at a beginning of the queue and a bucket with a most amount of uniformity at an end of the queue, and wherein the queue is processed from the beginning of the queue to the end of the queue.

21. The device of claim 15, wherein decomposing the selected bucket into a plurality of decomposed buckets includes dividing the selected bucket into a plurality of smaller buckets.
